(19) United States
(12) Patent Application Publication
(10) Pub. No.: US 2011/0178873 A1
(43) Pub. Date: Jul. 21, 2011

(54) Electronic Advertising

(76) Inventor: Frankie James Lagudi, New South Wales (AU)

(21) Appl. No.: 12/996,611

(22) PCT Filed: Jun. 5, 2009
(86) PCT No.: PCT/AU2009/000716

§ 371 Date: Mar. 14, 2011

(30) Foreign Application Priority Data
Jun. 5, 2008 (AU) 2008902872

(51) Int. Cl. G06Q 30/00

(52) U.S. Cl. 705/14.54; 705/14.68; 705/14.73; 705/14.57; 705/14.58; 705/14.53

(57) ABSTRACT

The invention provides an electronic advertising system (200) having an electronic advertising board (210) with a number of advertising slots (230). Each slot (230) can contain an advertisement (225). If all advertising slots (230) are full, one or more of advertising slots (230) can be cleared to accommodate a new advertisement, in accordance with a chosen criterion. The criterion may be selected from a range including date, price, category, products/services, location, or randomly.

### TECHNICAL FIELD

The field of this invention is generally related to advertising and more particularly to advertising over the Internet.

### BACKGROUND OF THE INVENTION

Advertising of goods or services on the Internet is commonplace today. Typically, advertising over the Internet involves an advertising provider who hosts an advertiser's advertisement in a particular webspace. The advertising may be provided for remuneration or without charge.

Typically, once an advertising campaign has been commenced by an advertiser, the campaign will be managed solely by the advertising provider and the advertiser may have little involvement in the actual placement of the advertisements. In particular there may be no system in place for determining when the advertisement appears on the website.

Additionally, advertisements placed by an advertising provider may remain the same for long durations of time and become ‘stale’ and as a consequence, web users may lose interest in these advertisements.

Web users may also find that advertisements located by them on the Internet have little relevance because their goods or services advertised are not located conveniently close to the web user's location or do not suit the web user's preferences. The web user may therefore waste considerable time in filtering through advertisements which are not useful to the web user.

A need therefore exists for an advertising system that addresses one or more of the above problems.

### SUMMARY OF THE INVENTION

According to one aspect of the present invention, there is provided an electronic advertising system including an electronic advertising board having a plurality of advertising slots, each slot adapted to contain an advertisement, and means for clearing at least one of the advertising slots of its advertisement in accordance with a chosen criterion.

According to another aspect of the present invention, there is provided an electronic advertising system including an electronic advertising board having an advertising slot, input means for input of data for an advertisement, means for storing the input data for the advertisement and means for selection of the input data for the advertisement for insertion in the advertising slot in accordance with a chosen criterion.

According to a third aspect of the present invention, there is provided an electronic advertising system including an electronic advertising board having a plurality of advertising slots, each slot adapted to contain an advertisement, and means for sorting the advertisements in the advertising slots according to a geographic location or preferences of a web user viewing the electronic advertising board.

In a fourth aspect, the invention provides a method for clearing an electronic advertising board, the method including the steps of:
providing an advertisement in each of a plurality of advertising slots in the electronic advertising board; and
clearing at least one of the advertising slots of its advertisement in accordance with a chosen criterion.

In a fifth aspect, the invention provides a method for selection of a new advertisement for insertion in an advertising slot in an electronic advertising board, the method including the steps of:
accepting input data for the new advertisement;
storing the input data for the new advertisement in a storage means,
checking for an empty advertising slot on the electronic advertising board; and
either inserting the new advertisement in an empty advertising slot; or
in the event that the electronic advertising board has no empty advertising slot, clearing another advertisement from its advertising slot and inserting the new advertisement in the empty advertising slot according to a chosen criterion.

In a sixth aspect, the present invention provides a method for sorting advertisements in an electronic advertising board having a plurality of advertising slots, each slot adapted to contain an advertisement, the method including the steps of:
accepting an inquiry from a web user;
selecting advertisements on electronic advertising board in accordance with the web user's inquiry;
ascertaining the geographical location or preferences of the web user; and
sorting the selected advertisements according to the geographical location or preferences of the web user.

The systems and methods of the invention, in one or more of their various aspects, may include an interface for use by an advertiser to submit an advertisement. The advertiser may be able to enter advertising information directly into an empty advertising slot in some circumstances, via the interface.

The input means may include such an interface. For example, an advertiser may use the advertiser's personal computer with connection to the Internet to access the electronic advertising system.

Means for storing input data is preferably a database attached to a web server. Preferably, data input for an advertisement is stored in a database in each of the aspects of the invention. This can facilitate queuing of advertisements when desired, especially in those aspects of the invention which deal with insertion of advertisements in an electronic advertising board presently having no vacant advertising slots.

In relation to the means for selection of the input data for insertion in the advertising slot in accordance with a chosen criterion, the criterion may be selected from a wide range of suitable criteria. By way of example, the criterion may be chosen from category, geography, product, location or price. In one preferred embodiment, the criterion relies on the date or time at which the data for the advertisement was input. This may be referred to as a “first-come-first-served” basis. Advertisements for which data has been input at an earlier time or date will be selected in priority to advertisements for which data has been input at a later date, in this embodiment.

The selection means may take any desirable form but preferably includes a processor driven by appropriate software.
1. The means for clearing at least one of the advertising slots of its advertisements in accordance with a chosen criterion may also take the form of a processor driven by appropriate software. The criterion itself may be chosen from a wide range of criteria, such as:
   position of its advertisement in the electronic advertising board;
   date of its advertisement;
   price included in its advertisement;
   category of product/service included in its advertisement;
   type of product or service referred to in its advertisement;
   location referred to in its advertisement;
   random selection of its advertisement;
   expiration of a chosen period;
   a predetermined time of day;
   a random of time of day; or
   a chosen number of visits to and/or impressions of the electronic advertising board.

Preferably, the criterion is chosen from the following:
1. When all the advertising slots in the electronic advertising board are full, and a new advertisement is presented for insertion in an advertising slot, the topmost advertisement of the advertising board is removed, effectively moving all advertisements upwards, and the new advertisement is placed in the empty spot which will appear at the bottom of the electronic advertising board.
2. When the electronic advertising board has no empty advertising slots and a new advertisement is presented for inclusion in the board, one of the existing advertising slots is cleared of its advertisement according to date, price, category, product, location, random number and/or random time of day.
   In the embodiment relating to date, the oldest advertisement is removed from its slot. The new advertisement is then inserted in that slot.
   Optionally, the order of advertising slots may be changed after removal of any advertisement.
   If the selected criterion relates to price, the advertisement having the highest or the lowest price may be removed so that the new advertisement can be inserted. If category is the criterion, one of the advertisements in that same category may be removed so that the new advertisement can be inserted. If there is more than one advertisement in the chosen category, there may be a second selection process. For example, the oldest or the most/least expensive advertisement in that category may be removed.
   Similarly, selection may rely on the particular product in the new advertisement, similarly to the category selection.
   Selection may rely on the location of advertiser, with removal of an existing advertisement in the same location.
   If the criterion is random number or time, then one of the existing advertisements is removed randomly or at a random time.

As indicated above, advertisements awaiting insertion in the electronic advertising board may be queued, preferably using the storage means, such a database. In this embodiment, selection of the input data for insertion in the advertising slot may include discarding advertisements in the queue for insertion. The discarded advertisement may be, for example, the first advertisement or the last advertisement submitted to the queue.

Clearing of the advertising board may take place manually or automatically.

One criterion for clearing, especially useful for automatic clearing, is the expiration of a chosen time period. For example, the system may be programmed to clear an advertisement once it has been displayed for 24 hours.

In another embodiment, all or some of the advertisements are cleared at a predetermined time of day or at a random time of day.

As another embodiment, all or some of the advertisements are cleared once the electronic advertising board becomes full—ie, all advertising slots are occupied. This criterion may be used manually or programmed to be used automatically.

In yet another embodiment, the advertising board may be cleared after a chosen number of page hits has been met or exceeded.

In relation to the aspect of the invention in which the advertisements are sorted according to geographic location of a web user, the location of the web user may be established in any suitable way. As one example, the IP address of the web user may be read by the system, for example, by a web server.

In another embodiment, a web user may input user preferences, optionally including a geographic location, and sorting may take place in accordance with these user preferences.

The electronic advertising system of the invention may, in suitable aspects or embodiments, sort advertisements according to relevance of the advertisements to the web user, in aspects other than or additional to location of the web user. For example, the system or method may ascertain or infer browsing history of the web user and use this information to sort advertisements.

### BRIEF DESCRIPTION OF THE DRAWINGS

Some aspects of one or more non-limiting embodiments of the present invention will now be described with reference to the drawings, in which:

FIG. 1 shows an embodiment of advertising board system for providing advertisements over the Internet;

FIG. 2 shows an embodiment of advertising board for displaying advertisements;

FIG. 3 shows an embodiment of interfaces that may be used by an advertiser to submit an advertisement;

FIG. 4 show embodiments of methods for selecting a new advertisement for insertion in the advertising board;

FIGS. 5A to 5D show embodiments of methods for automatically clearing the advertising board;

FIGS. 6A to 6C show embodiments of methods for sorting advertisements in the advertising slots contained in the advertising board;

FIG. 7 is a schematic block diagram of a general purpose computer upon which arrangements described in the Figures can be practiced; and

FIG. 8 is a screenshot of an embodiment of the system of the invention where advertisements have been sorted according to geographic location of a web user.

### DETAILED DESCRIPTION OF THE DRAWINGS

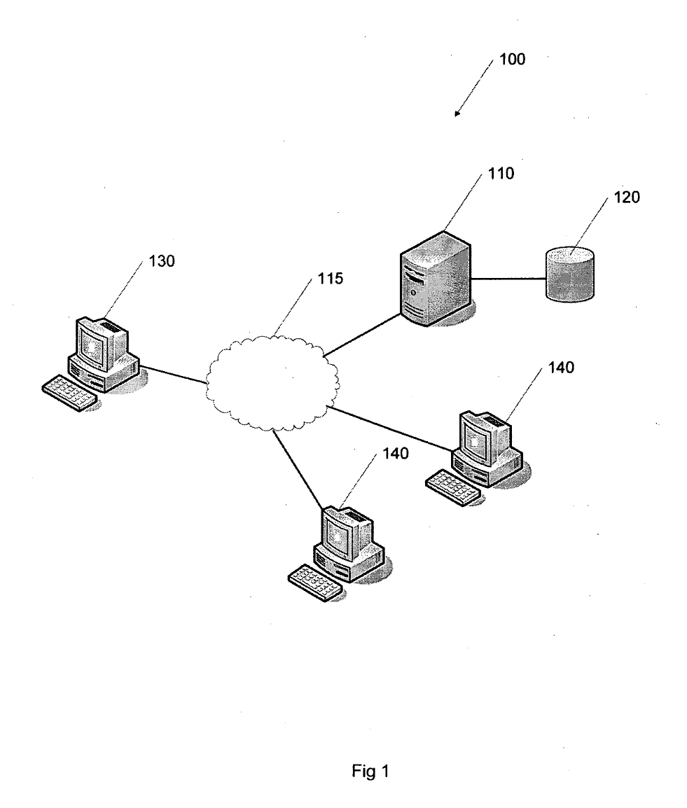

FIG. 1 shows an electronic advertising board system 100 for providing advertisements over the Internet 115. The web server 110 typically includes a database 120 to store the web page content.

In a manner known in the art, upon receiving an HTTP request, the web server retrieves the requested HTML page, pre processes the HTML page with data comprising data extracted from the database 120 and serves the resultant HTML page as a response. In a preferred embodiment, the web server is an Apache™ web server, the HTML pre-processor is a PHP pre-processor and the database is a MySql™ database.

In the system 100, the web server is typically configured from the web master workstation 130. Using the web master workstation 130, the web master is able to configure the stored HTML pages and data contained in the database 120 of the web server 100. Typically, the web master may perform the configuration using the HTTP, HTTPS or FTP protocols.

In the system 100, web users use web user workstations 140 to request and view the HTML pages received from the web server 100. Typically, the web user workstations contain a browser application that issues a request for a particular HTML page from the web server 100, receives the HTML response from the web server 100 and renders the response on the display of the web user workstation 140.

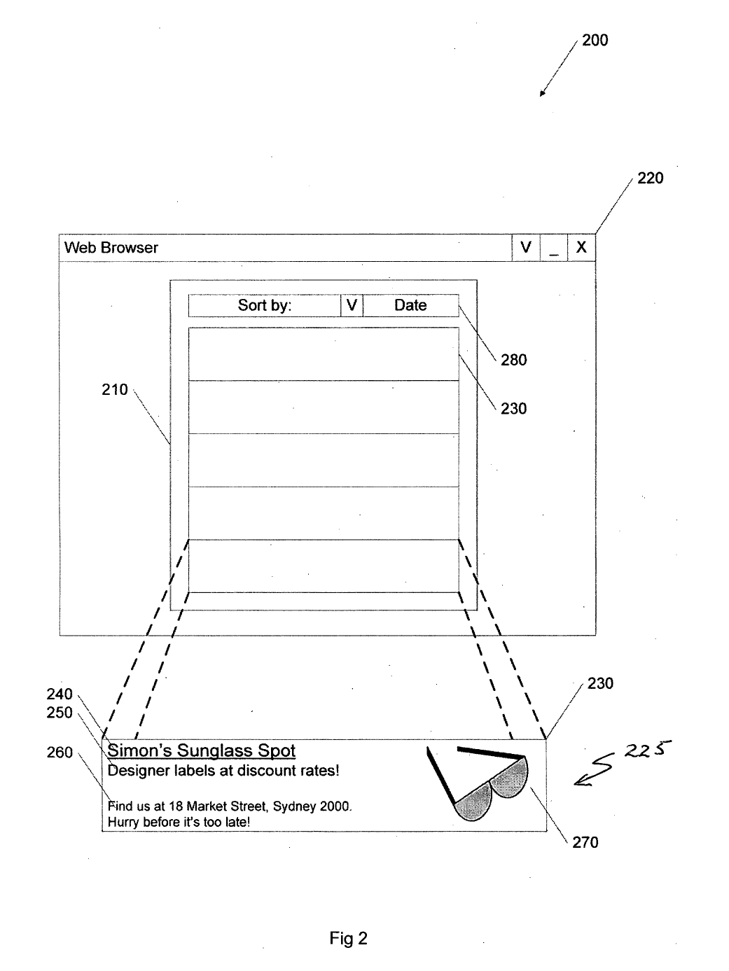

FIG. 2 shows an electronic advertising system 200 having an advertising board 210 for displaying advertisements 225 related to goods or services. Typically, the advertising board 210 is rendered by a browser application 220 on the display device of a web user workstation 140. The advertising board 210 typically comprises a portion of the rendered HTML page within the browser application 220 but may alternatively comprise the full rendered area of the browser application 220.

The advertising board 210 contains a number of advertising slots 230 in which advertisements may be displayed. An advertising slot 230 may contain a hyperlinked title 240 of the advertisement.

Typically, the title 240 hyperlink contains a URL that refers to the web page configured by the advertiser (also known as a merchant).

As a second option, the title 240 hyperlink may contain a URL that refers to a webpage within the same domain. As a third option, the title 240 hyperlink may contain a URL that refers to any webpage.

The advertising slot 230 may further comprise a tag line 250 and detailed information 260. In a preferred embodiment, the detailed information 260 contains the address of the advertiser but may contain additional information related to the advertisement, such as “specials”. The advertising slot 230 may also contain an image 270 which is typically configurable by the advertiser.

The advertising board 210 may contain advertisements from a plurality of advertisers in the advertising slots 230. If not all the advertising slots are filled, one or more slots 230 will be left blank or a default advertisement inserted.

The advertising board 210 may further include a sorting control 280 that allows a web user to sort the order of the advertisements in the advertisement slots 230. Typically, a sorting control 280 contains a drop down box containing a number of options by which to sort the advertisements. In this manner, the web user may be able to sort the advertisements by date, by location, by relevance or by any other criteria.

In a preferred embodiment, an asynchronous JavaScript™ function call is used to update the order of the advertising slots 230, thereby eliminating the need for a page refresh.

In a preferred embodiment, a plurality of advertising boards 210 may exist on separate web pages within a same domain In this manner, each web page may pertain to a particular geographic state or region. Thus there may be a plurality of state pages. Each advertising board on a state page might only include advertisements that are related to that particular state.

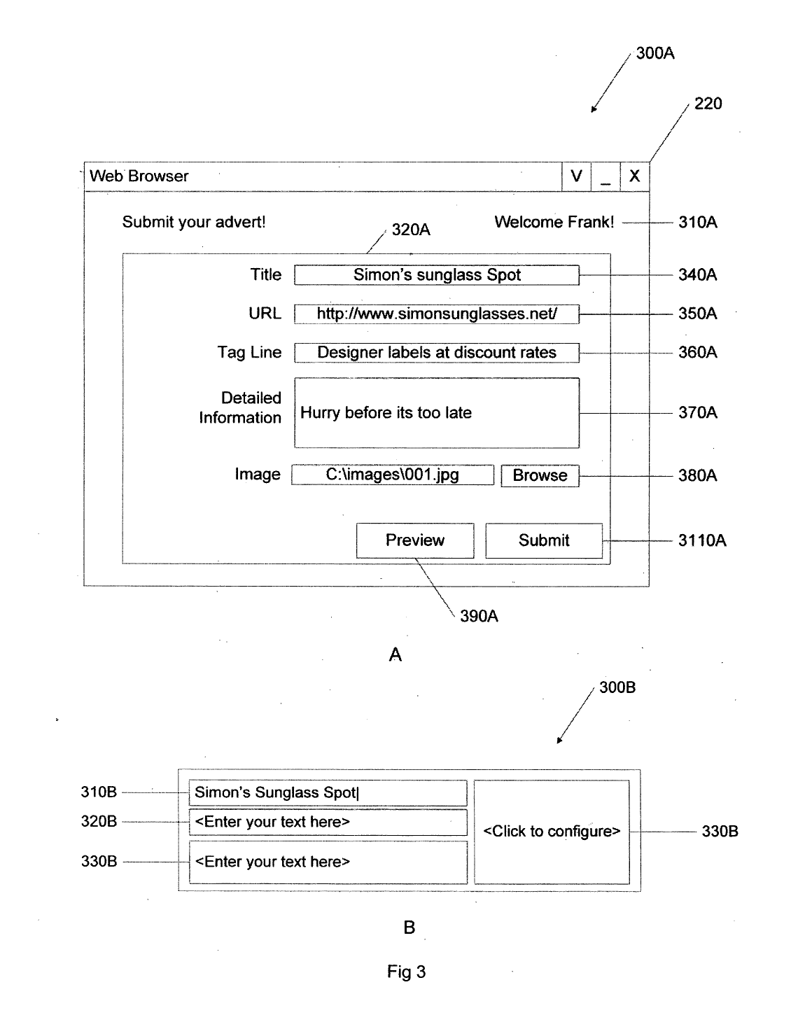

FIG. 3 shows interfaces that may be used by the advertiser to submit an advertisement. The interfaces 300A, 300B are rendered in a browser application 220. In order for an advertiser to view interfaces 300A or 300B, the advertiser must log on or authenticate to the web server 110 in a manner known in the art. In a preferred embodiment, an advertiser will provide the advertiser's email address when registering with the web server 110. The web server will then send a confirmation email to the email address provided by the advertiser containing a URL. The URL refers to a page on the web server 110 that, when requested, verifies that the advertiser email address is valid. After an advertiser has registered with a web server 110, the advertiser may log into the web server 110 in order to request to place an advertisement on the advertising board 210.

In the user interface 300A the web user is identified by a welcome note 310A to indicate to the advertiser that he has logged in. The user interface 300A contains a form 320A containing input fields pertaining to the data contained in an advertisement. Typically, the form 320A may contain a title text input field 340A and a URL input field 350A. In this manner, the title of the advertisement may contain a hyperlink as specified in the URL text input field 350A. Additionally, the form 320A may contain tagline 360A and detailed information 370A text input fields. The form 320A may contain an image field that allows an advertiser to browse and upload an image stored on the client workstation 140. The form 320A may contain a preview button 390A which will show a preview of the advertisement as it would be rendered in the advertising slot 230 to the web user. The form 320A contains a submit button 3110A which submits the form information to the web server 110 to be stored in the database 120.

The interface 300B is one that an advertiser may use to enter in advertising information directly on the advertising board 210 without having to browse to the advertisement information input interface 300A. The interface 300B is advantageous, because it is user friendly and requires fewer steps to enter advertising data. In order to view interface 300B, the advertiser will have to log into the web server 100. If the advertiser is not logged into the system, an appropriate message such as “Please log in if you want to advertise in this slot” may be temporarily displayed as the advertiser moves the cursor over the advertising slot 230. If the advertiser is logged into the system, text input fields 310B, 320B, 330B and an image edit link 330B may appear when the advertiser moves the mouse cursor over the advertisement slot 230. The advertiser is able to enter the advertising data in fields 310B, 320B and 330B. Once the data has been input into the fields, it is automatically submitted to the web server 110 for inclusion in the database 120. Alternatively, the data may be submitted manually by the advertiser clicking a submit button. When the advertiser clicks on field 330B, a new window may open allowing the advertiser to choose the image from the web user workstation 140.

Alternatively, field 300B may be a browse button, allowing the advertiser to browse for the image on the web user workstation 140. In a preferred embodiment, asynchronous JavaScript™ function calls will be used to eliminate the need for page refreshing.

In a preferred embodiment, the input fields of interfaces 300A and 300B are automatically populated with information. In this manner, the detailed description 260 (FIG. 2.) may be automatically populated with the address of the advertiser if it is known. In another example, the location of the advertiser may be ascertained from the advertiser's IP address and the name of the location used to automatically populate the detailed description field 260.

In a preferred embodiment, the web server 110 is configured to limit the number of advertisements that a particular advertiser can submit in a certain period. For instance, the web server 110 may be configured to only allow a user to post advertisement in a 24 hour period.

In a preferred embodiment, the web server 110 is configured to limit when advertisers may post advertisements. For instance, the web server 110 may be configured to only allow an advertiser to post advertisements during the first 8 hours of every day.

Alternatively, the web server 110 may be configured to only allow advertisers to post advertisements at certain random times during the day. This is advantageous as it may cause the advertisers to keep checking the web page in order to determine when advertising posting is enabled.

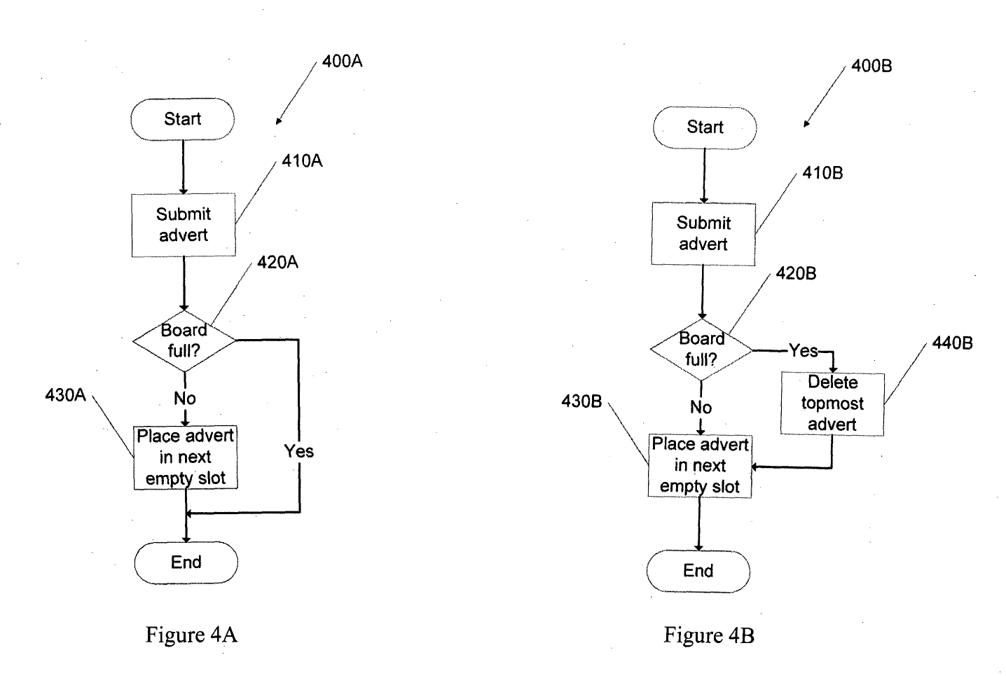

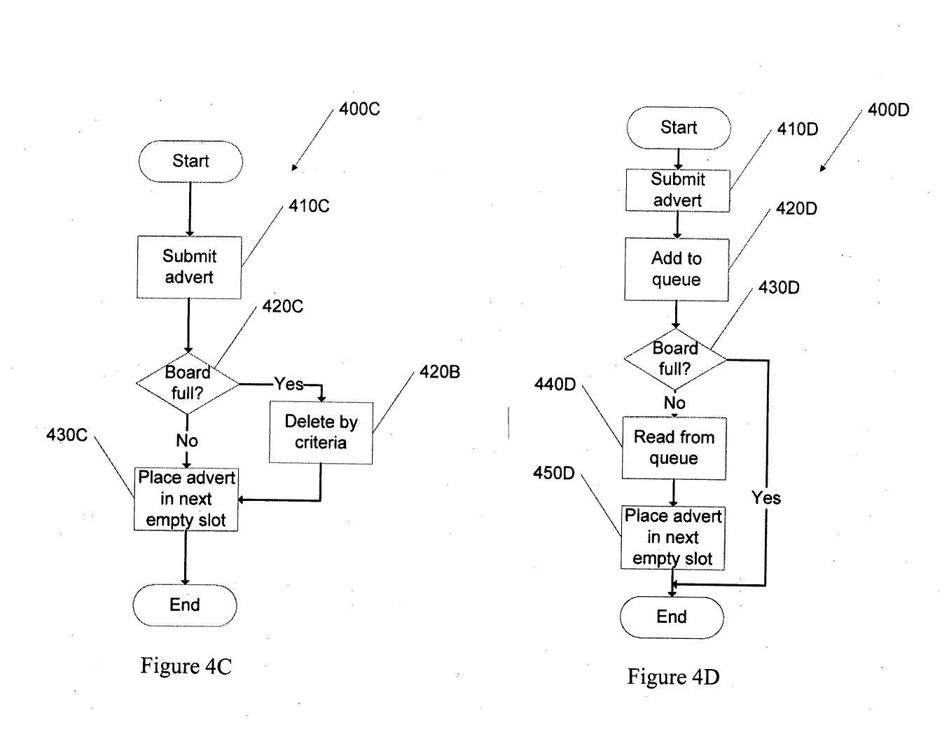

FIGS. 4A to 4D show methods for selecting and posting an advertisement to the advertising board 210.

Method 400A in FIG. 4A shows a method of posting an advertisement to the advertising board on a first-come-first-served basis. In method 400A an advertiser submits an advertisement at step 410A. At step 420A the web server 110 determines if all of the advertising slots 230 in the advertising board 210 are full (refer FIG. 2). If all of the advertising slots 230 of the advertising board 210 are not full, the web server 110 at step 430A will place the submitted advertisement in the next empty slot 230 of the advertising board 210. In this manner, the first advertisement submitted by the advertiser will appear at the top of the advertising board. Subsequent advertisements will appear in advertising slots 230 below in the order in which they were submitted.

If the web server 110 at step 420A determines that the advertising board 210 is full, the submitted advertisement is not posted to the advertising board.

A PHP code snippet for method 400A is given in Table 1.

TABLE 1
(Method 400A)

<?php
//function to submit an advert
//according to the first come, first served method
function first_served_submit($title,$tag,$details)
{
//query to count the number of
//ads in the database
$result = mysql_query(‘SELECT COUNT(*) FROM db_ads’);
//if there are less than 10 advertisements
//in the database
if(mysql_result($result,0) < 10)
{
mysql_query(sprintf(‘INSERT INTO db_ads SET
title=’%s’, $tag=’%s’, details=’%s’),$title,$tag,$details);
}
}
?>

Method 400B in FIG. 4B shows a method of posting advertisements to the advertising board analogous to a first-in-first-out stack. At step 410B the advertiser submits an advertisement. At step 420B the web server 110 determines if the advertising board 210 is full. If the advertising board is not full at step 430B, the advertisement is placed in the next empty slot of the advertising board 210. If, however, the advertising board is full, the topmost advertisement of the advertising board 210 is removed at step 440B. The advertisement is placed in the bottom empty slot at step 430B.

A PHP code snippet for method 400B is given in Table 2.

TABLE 2
(Method 400B)

<?php
//function to submit an advert
//according to the FIFO stack
function first_served_submit($title,$tag,$details)
{
//query to count the number of
//ads in the database
$result = mysql_query(‘SELECT COUNT(*) FROM db_ads’);
//if there are more than 10 advertisements
//in the database
if(mysql_result($result,0) > 10)
{
//delete the oldest advert
mysql_query(‘DELETE * FROM db_ads LIMIT 1, ORDER BY
index ACS’);
}
mysql_query(sprintf(‘INSERT INTO db_ads SET title=’%s’,
$tag=’%s’, details=’%s’),$title,$tag,$details);
}
?>

Method 400C in FIG. 4C is a method of posting advertisements to the advertising board 210 when a criterion is used to determine which advertisement is removed if the board is full. The criteria for posting advertisements to the advertising board 210 that is full, for example, may include removing an advertisement from the advertising board 210 according to date, price, category, product, location or random number.

In method 400C, the advertiser submits an advertisement at step 410C. At step 420C, the web server 110 determines if the advertising board 210 is full or not. If the advertising board 210 is full the web server 110 uses the predetermined criteria to remove a particular advertisement from the advertising board at step 420B. At step 430C, the advertisement is placed in the empty slot of the advertising board 210.

A PHP code snippet for method 400B is given in Table 3.

TABLE 3
(Method 400C)

<?php
//function to submit an advert
//and removing an advertisement by using the date as a criterion
function_first_served_submit($title,$tag,$details)
{
//query to count the number of
//ads in the database
$result = mysql_query(‘SELECT COUNT(*) FROM db_ads’);
//if there are more than 10 advertisements
//in the database
if(mysql_result($result,0) > 10)
{
//delete the oldest advert
mysql_query(‘DELETE * FROM db_ads LIMIT 1, ORDER BY
date ACS’);
}
mysql_query(sprintf(‘INSERT INTO db_ads SET title=’%s’,
$tag=’%s’, details=’%s’),$title,$tag,$details);
}
?>

Method 400D in FIG. 4D shows steps for posting advertisements to the advertising board 210 in which excess advertisements are queued. In method 400D, an advertiser submits an advertisement at step 410D. At step 420D, the submitted advertisement is added to a queue. The queue may be a fixed or variable length array. In the variable length array, the array is grown to accommodate advertisements as they are submitted.

Advertisements may also be discarded from the queue once a threshold has been exceeded. The discarded advertisement may be the first advertisement or the last advertisement submitted to the queue.

At step 430D, the web server 110 determines if the advertising board 210 is full or not. If the advertising board 210 is full, no advertisement is posted to the advertising board. If the advertising board is not full, an advertisement is read from the queue at step 440D and posted to the advertising board at step 450D.

A PHP code snippet for method 400D is given in Table 4.

TABLE 4
(Method 400D)

<?php
//function to submit an advert
//using a queue
function first_served_submit($title,$tag,$details)
{
//get scope
global $queue;
//create an array to add to the queue
$bit = array(“title” => $title, “tag” => $tag, “details” =>
$details),
//add the array to the queue
array_push($queue,$bit);
//query to count the number of
//ads in the database
$result = mysql_query(‘SELECT COUNT(*) FROM db_ads’);
//if there are less than 10 advertisements
//in the database
if(mysql_result($result,0) < 10)
{
//read from the array
$bit = array_pop($queue);
mysql_query(sprintf(‘INSERT INTO db_ads SET
title=’%s’, $tag=’%s’, details=’%s’),$bit[‘title’], $bit[‘tag’],
$bit[‘details’]);
}
}
?>

In a preferred embodiment, advertisements are automatically cleared from the board after the expiration of a certain time period, and an advertisement from the queue is place in its stead. For example, if an advertiser's advertisement is posted to the advertising board at 12 hours, 41 minutes, the advertisement will remain on the board until 24 hours later at which time the advertisement is removed from the board and replaced with an advertisement from the advertising queue.

In another preferred embodiment, if an advertisement of an advertiser is in the queue, the advertiser is given feedback on the time remaining until the advertisement will be posted to the advertising board.

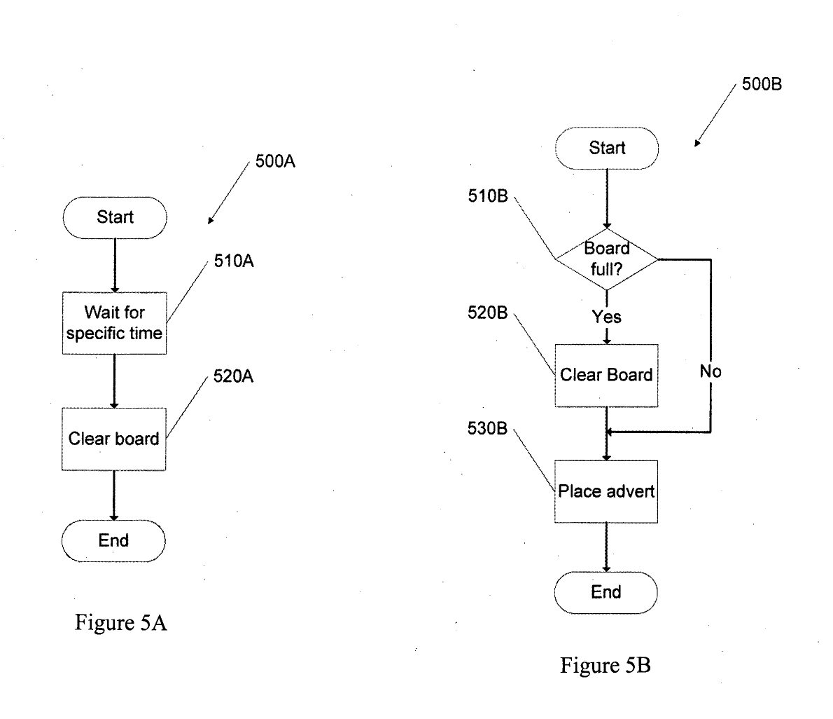

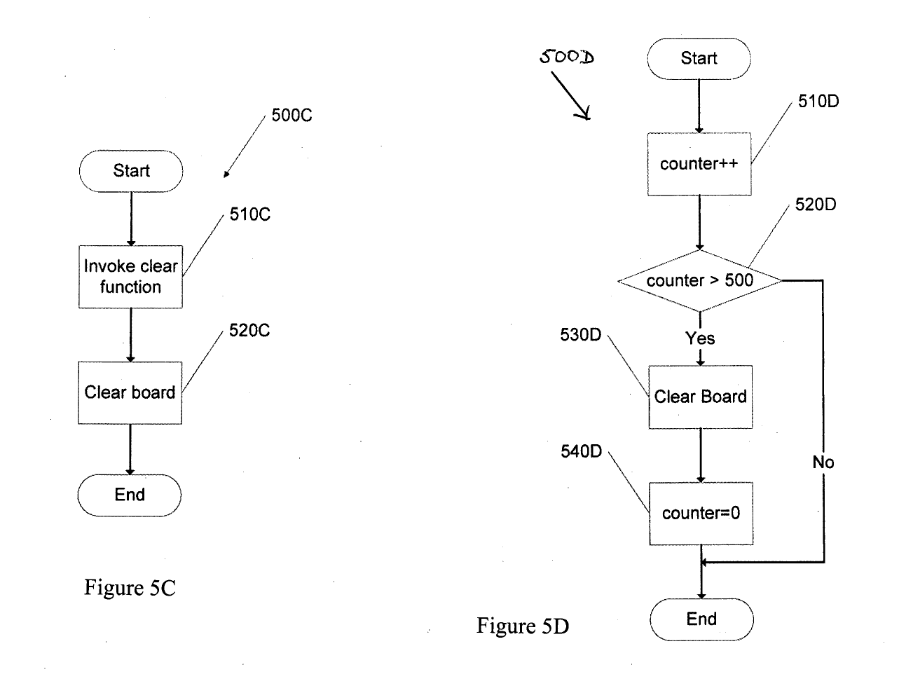

FIG. 5A to 5D show methods for automatically clearing the advertising board.

Method 500A in FIG. 5A shows a method for automatically clearing the advertising board at a specific time

The specific time may be a predetermined time of day or a random time of day. In method 500A, the web server 110 waits for a specific time (step 510A). At step 520A. the advertising board 210 is cleared. In a preferred embodiment, a cronjob (see: http://www.cronjobs.org/) is used to invoke step 520 periodically.

A PHP code snippet of step 520A of method 500A is given in Table 5.

TABLE 5
(Method 500A)

<?php
function clear_board( )
{
mysql_query(‘DELETE (*) FROM db_ads’);
}
?>

Method 500B in FIG. 5B shows a method for clearing the advertising board 210 when the advertising board is full. The method 500B begins at step 510B where the web server 110 determines if the advertising board 120 is full or not. If the advertising board is full, the advertising board 120 is cleared at step 520B. At step 530B, the advertisement is posted to the advertising board 120 in the usual manner.

A PHP code snippet of method 500B is given in Table 6.

TABLE 6
(Method 500B)

<?php
function post_advert($title,$tag,$details)
}
//query to count the number of
//ads in the database
$result = mysql_query(‘SELECT COUNT(*) FROM db_ads’);
//if there are more than 10 advertisements
//in the database
if(mysql_result($result,0) > 10)
{
mysql_query(‘DELETE (*) FROM db_ads’);
}
mysql_query(sprintf(‘INSERT INTO db_ads SET title=’%s’,
$tag=’%s’, details=’%s’),$title,$tag,$details);
}
?>

Method 500C in FIG. 5C shows a method for manually clearing the advertising board. In a preferred embodiment, the web master, using the web master workstation 130, is able to clear the advertising board. The web master may invoke the clearing of the board by accessing the secured web page contained on the web server 110 or by calling a web service function of the web server 110.

The method 500C starts at step 510C when the web master invokes the clearing of the board. At step 520C the advertising board 210 is cleared.

The PHP that may be used to clear the board is shown in Table 5.

Method 500D in FIG. 5D shows a method of clearing the advertising board 210 once a predetermined number of page hits has been exceeded. In method 500D, a counter is used to keep track of the number of web page hits. At step 510D, the page hit counter is increased by one. At step 520D, the web server 110 determines if the page counter has exceeded a certain threshold. If the page counter has exceeded a certain threshold, the advertising board 210 is cleared at step 530D. At step 540D the page counter is reset to zero.

A PHP code snippet of method 500D is given in Table 7.

TABLE 7
(Method 500D)

<?php
function clear_board( )
{
//get scope
global $counter;
//increment the counter
$counter++;
//if the counter exceeds 500, clear the board
if($counter > 500)
{
mysql_query(‘DELETE (*) FROM db_ads’);
//reset the counter
$counter=0;
}
}
?>

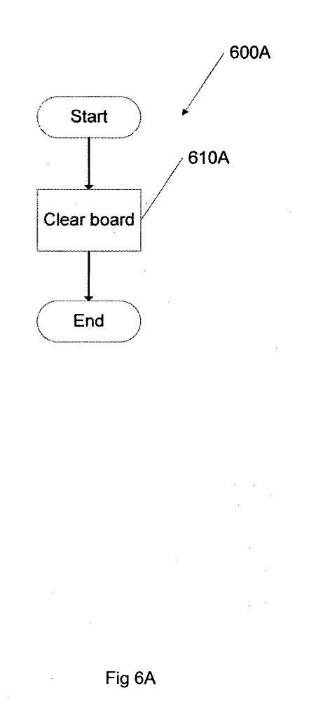

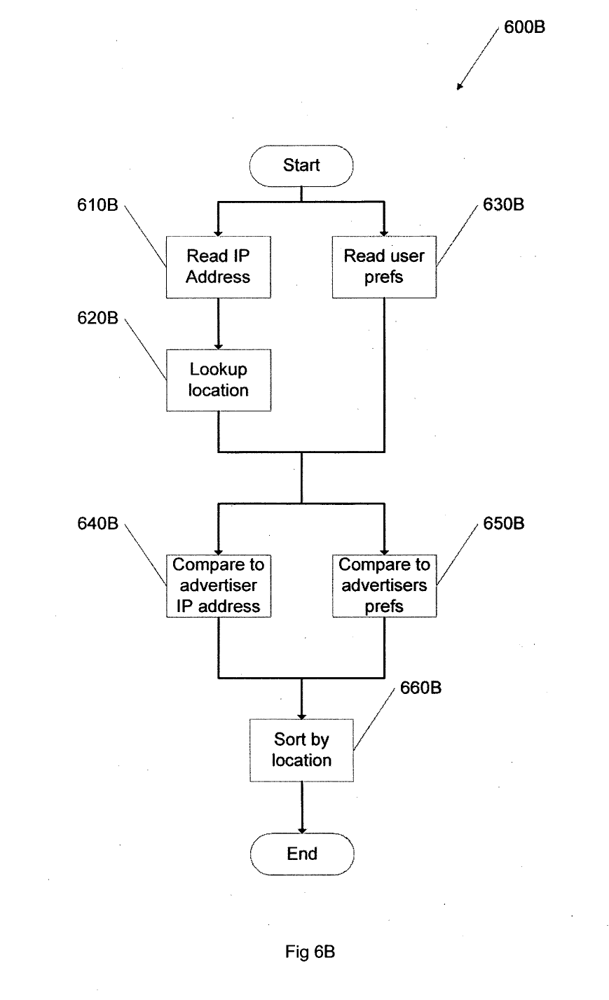

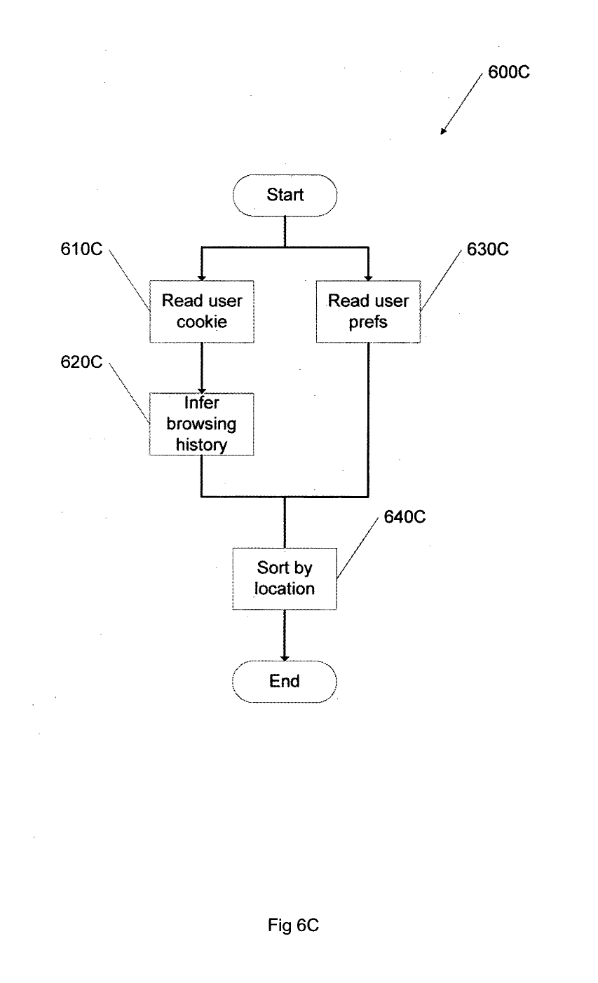

FIGS. 6A to 6C show methods for sorting advertisements in the advertising slots 230 contained in the advertising board 210 (refer FIG. 2).

Method 600A shows a method for sorting the advertisements in the advertising board 210 according to the date and time at which they were submitted. According to this method, the web server 110 stores in the database 120 the time and date at which each advertisement is submitted. At step 610A, the advertisements contained in the advertising board 210 are sorted according to the time and date of each advertisement.

A SQL query example to sort the advertisements by data is given in Table 8.

TABLE 8
SQL query to sort advertisements by date

SELECT * FROM db_ads, ORDER BY date ASC

Method 600B in FIG. 6B shows a method for sorting advertisements in the advertising board according to location. In this manner, a web user is able to view advertisements near the top of the advertising board which are most relevant to the web user's location. In order to determine the location of the web user, the web server 110 may either read the IP address of the web user at step 610B or read the user's location from the user preferences in step 630B, if they exist. If the web server 110 uses the IP address of the web user to determine its location, a look up table is typically employed at step 620B in order to resolve the location of the web user.

In order to determine the advertisements most relevant by location, the web server 110 may either compare the location of the advertiser obtained from the IP address of the advertiser when the advertisement was submitted at step 640B with the location of the web user, or compare the advertiser location in the advertiser user preferences in step 650B with the location of the web user. At step 660B, the advertisements of the advertising board 210 are sorted as a function of the proximity of the web user location.

In other embodiments, the advertisements on the advertising board 210 may be sorted by category, geography, product, location or price. SQL query examples to sort the advertisements by these criteria are given in Table 9.

TABLE 9
SQL queries to sort advertisements

SELECT * FROM db_ads
ORDER BY category ASC
SELECT * FROM db_ads
ORDER BY geography DESC
SELECT * FROM db_ads
ORDER BY product ASC
SELECT * FROM db_ads
ORDER BY location DESC
SELECT * FROM db_ads
ORDER BY price DESC

Method 600C in FIG. 6C is a method of sorting advertisements in the advertising board 210 according to the relevance of the advertisement to the web user. In order to determine the characteristics or preferences of the web user, the web server 110 may read and write cookies at step 610C in order to infer the browsing history of the web user at step 620C. In this manner, the web server 110 may obtain a list of pages that the web user has visited. The web server 110 is then able to visit the same pages visited by the web user and store the relevant keywords contained in the content of those pages. These keywords will be used as an indication of user preferences.

Alternatively, the web server 110 may read the user preferences at step 630C, if they exist. In this manner, the web user is able to define a set of keywords to identify preferences.

At step 640C, the web server 110 will use the keywords gathered in step 610C to 620C or in step 630C to sort the advertisements according to an algorithm. In a preferred embodiment, the algorithm will match the user preference keywords with key words in the advertisements in the advertising board 210 and rank those advertisements according to the number of keywords that are the same or similar.

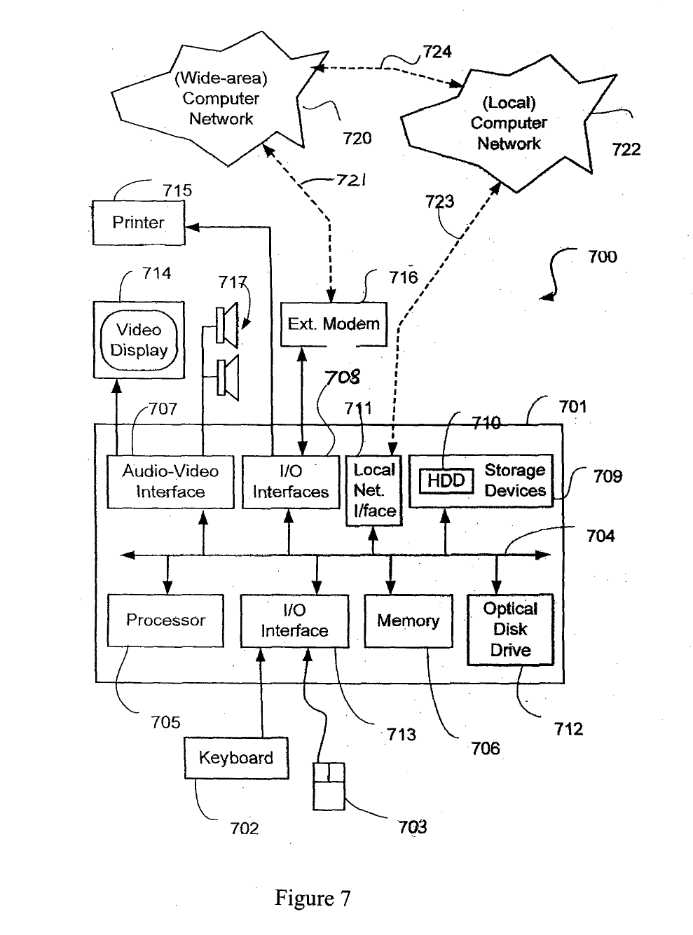

The method of FIGS. 4-6 may be implemented using a computer system 700, such as that shown in FIG. 7, wherein the processes are implemented as software, such as one or more application programs executable within the computer system 700. In particular, the steps of the methods shown in FIGS. 4-6 are effected by instructions in the software that are carried out within the computer system 700. The instructions may be formed as one or more code modules, each for performing one or more particular tasks. The software may also be divided into two separate parts, in which a first part and the corresponding code modules perform the methods shown in FIGS. 4-6 and a second part and the corresponding code modules manage a user interface between the first part and the advertiser as shown in FIGS. 2 and 3. The software may be stored in a computer readable medium, including the storage devices described below, for example. The software is loaded into the computer system 700 from the computer readable medium, and then executed by the computer system 700. A computer readable medium having such software or computer program recorded on it is a computer program product.

As seen in FIG. 7, the computer system 700 is formed by a computer module 701, input devices such as a keyboard 702 and a mouse pointer device 703, and output devices including a printer 715, a display device 714 and loudspeakers 717. An external Modulator-Demodulator (Modem) transceiver device 716 may be used by the computer module 701 for communicating to and from a communications network 720 via a connection 721. The network 720 may be a wide-area network (WAN), such as the Internet 115 or a private WAN. Where the connection 721 is a telephone line, the modem 716 may be a traditional “dial-up” modem. Alternatively, where the connection 721 is a high capacity (eg: cable) connection, the modem 716 may be a broadband modem. A wireless modem may also be used for wireless connection to the network 720.

The computer module 701 typically includes at least one processor unit 705, and a memory unit 706 for example formed from semiconductor random access memory (RAM) and read only memory (ROM). The module 701 also includes an number of input/output (I/O) interfaces including an audio-video interface 707 that couples to the video display 714 and loudspeakers 717, an I/O interface 713 for the keyboard 702 and mouse 703 and optionally a joystick (not illustrated), and an interface 708 for the external modem 716 and printer 715.

In some implementations, the modem 716 may be incorporated within the computer module 701, for example within the interface 708.

The computer module 701 also has a local network interface 711 which, via a connection 723, permits coupling of the computer system 700 to a local computer network 722, known as a Local Area Network (LAN). As also illustrated, the local network 722 may also couple to the wide network 720 via a connection 724, which would typically include a so-called “firewall” device or similar functionality. The interface 711 may be formed by an Ethernet™ circuit card, a wireless Bluetooth™ or an IEEE 802.11 wireless arrangement.

The interfaces 708 and 713 may afford both serial and parallel connectivity, the former typically being implemented according to the Universal Serial Bus (USB) standards and having corresponding USB connectors (not illustrated).

Storage devices 709 are provided and typically include a hard disk drive (HDD) 710. Other devices such as a floppy disk drive and a magnetic tape drive (not illustrated) may also be used. An optical disk drive 712 is typically provided to act as a non-volatile source of data. Portable memory devices, such as optical disks (eg: CD-ROM, DVD), USB-RAM, and floppy disks, for example, may then be used as appropriate sources of data to the system 700.

The components 705 to 713 of the computer module 701 typically communicate via an interconnected bus 704 and in a manner which results in a conventional mode of operation of the computer system 700, known to those in the relevant art. Examples of computers on which the described arrangements can be practiced include IBM-PCs and compatibles, Sun Sparcstations, Apple Mac™ or like computer systems evolved therefrom.

Typically, the application programs discussed above are resident on the hard disk drive 710 and read and controlled in execution by the processor 705. Intermediate storage of such programs and any data fetched from the networks 720 and 722 may be accomplished using the semiconductor memory 706, possibly in concert with the hard disk drive 710. In some instances, the application programs may be supplied to the user encoded on one or more CD-ROM and read via the corresponding drive 712, or alternatively may be read by the user from the networks 720 or 722. Still further, the software can also be loaded into the computer system 700 from other computer readable media. Computer readable media refers to any storage medium that participates in providing instructions and/or data to the computer system 700 for execution and/or processing. Examples of such media include floppy disks, magnetic tape, CD-ROM, a hard disk drive, a ROM or integrated circuit, a magneto-optical disk, or a computer readable card such as a PCMCIA card and the like, whether or not such devices are internal or external of the computer module 701. Examples of computer readable transmission media that may also participate in the provision of instructions and/or data include radio or infra-red transmission channels as well as a network connection to another computer or networked device, and the Internet 115 or Intranets including e-mail transmissions and information recorded on Websites and the like.

The second part of the application programs and the corresponding code modules mentioned above may be executed to implement one or more graphical user interfaces (GUIs) to be rendered or otherwise represented upon the display 714. Through manipulation of the keyboard 702 and the mouse 703, a user of the computer system 700 and the application may manipulate the interface to provide controlling commands and/or input to the applications associated with the GUI(s).

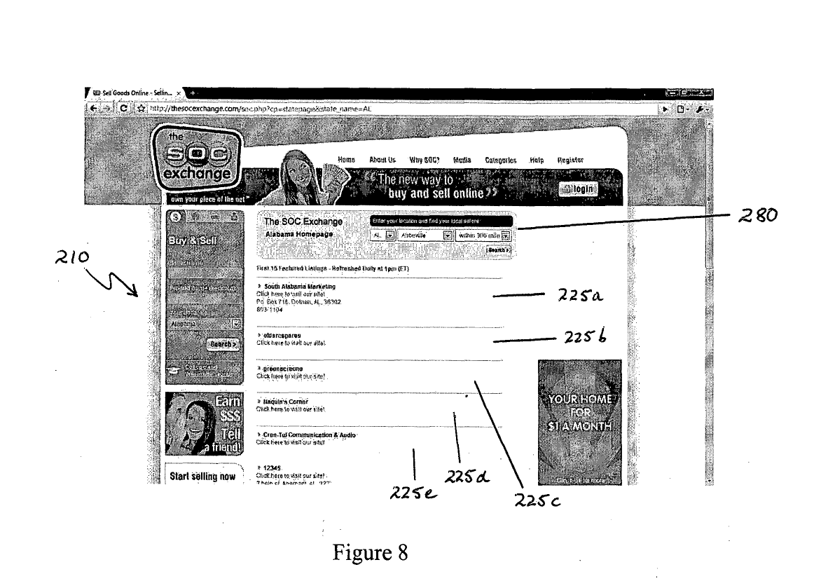

Turning now to FIG. 8, the appropriate labels from FIG. 2 will also be used in relation to this Figure.

Advertising board 210 is shown having several advertisements 225A, 225B, 225C, 225D and 225E. In this embodiment, the web user has entered in sorting control 280 the web user's preferences as to location of advertisements. In the example shown, the web user has entered criteria as to State (Alabama) and region (within 300 miles of the town of Abbeville).

As shown, the web user has been presented with the advertisements 225a to 225b which correspond to the web user's geographic criterion, having sorted the advertisements in accordance with that criterion.

### INDUSTRIAL APPLICABILITY

It will be appreciated by one skilled in the art that systems and methods of the invention may provide in various embodiments an improvement on current advertising systems, enabling efficient posting of advertisements and the ability to maintain posted advertisements in useful yet current manner.

1. An electronic advertising system including an electronic advertising board having a plurality of advertising slots, each slot adapted to contain an advertisement, and means for clearing at least one of the advertising slots of its advertisement in accordance with a chosen criterion.

2. The system of claim 1, wherein the chosen criterion is selected from:
position of its advertisement in the electronic advertising board;
date of its advertisement;
price included in its advertisement;
category of product/service included in its advertisement;
type of product or service referred to in its advertisement;
location referred to in its advertisement;
random selection of its advertisement;
expiration of a chosen period;
a predetermined time of day;
a random of time of day; or
a chosen number of visits to and/or impressions of the electronic advertising board.

3. The system of claim 1, wherein the clearing means is adapted to clear all of the advertising slots in accordance with a criterion chosen from:
the occupation of all the advertising slots;
a predetermined time of day;
a random time of day; or
a chosen number of visits to or impressions of the electronic advertising board.

4. The system of any one of claims 1 to 3, wherein the clearing means is adapted to be operated manually.

5. The system of any one of claims 1 to 3, wherein the clearing means is adapted to operate automatically.

6. An electronic advertising system including an electronic advertising board having an advertising slot, input means for input of data for an advertisement, means for storing the input data for the advertisement and means for selection of the input data for the advertisement for insertion in the advertising slot in accordance with a chosen criterion.

7. The system of claim 2, wherein the chosen criterion is selected from:
date of the input data for the advertisement;
price included in the advertisement;
category of product/service included in the advertisement;
type of product or service referred to in the advertisement;
location referred to in the advertisement.

8. The system of claim 2, wherein the means for storing input data includes a database attached to a web server.

9. An electronic advertising system including an electronic advertising board having a plurality of advertising slots, each slot adapted to contain an advertisement, and means for sorting the advertisements in the advertising slots according to a geographic location or preferences of a web user viewing the electronic advertising board.

10. The system of claim 9, wherein the geographic location of the web user is established from an IP address provided by the web user.

11. The system of claim 9 which includes means for ascertaining browsing history of the web user in order to ascertain preferences of the web user.

12. The system of claim 1 or 3 which includes a database attached to a web server for storing input data for each advertisement.

13. The system of any one of claims 1 to 12 which includes an interface for use by an advertiser to submit an advertisement.

14. A method for clearing an electronic advertising board, the method including the steps of:
providing an advertisement in each of a plurality of advertising slots in the electronic advertising board; and
clearing at least one of the advertising slots of its advertisement in accordance with a chosen criterion.

15. A method for selection of a new advertisement for insertion in an advertising slot in an electronic advertising board, the method including the steps of:
accepting input data for the advertisement;
storing the input data for the new advertisement in a storage means:
checking for an empty advertising slot on the electronic advertising board; and
either inserting the new advertisement in an empty advertising slot; or
in the event that the electronic advertising board has no empty advertising slot, clearing another advertisement from its advertising slot according to a chosen criterion and inserting the new advertisement in the empty advertising slot.

16. The method of claim 14 or 15 wherein the chosen criterion is selected from:
date of the advertisement to be cleared;
price included in the advertisement to be cleared;
category of product/services included in the advertisement to be cleared;
type of product or service referred to in the advertisement to be cleared;
location referred to in the advertisement to be cleared.

17. The method of claim 14, wherein the chosen criterion is selected from:
position of its advertisement in the electronic advertising board;
random selection of its advertisement;
expiration of a chosen period;
a predetermined time of day;
a random of time of day; or
a chosen number of visits to or impressions of the electronic advertising board.

18. A method for sorting advertisements in an electronic advertising board having a plurality of advertising slots, each slot adapted to contain an advertisement, the method including the steps of:
accepting an inquiry from a web user;
selecting advertisements on an electronic advertising board in accordance with the web user's inquiry;
ascertaining the geographical location or preferences of the web user; and
sorting the selected advertisements according to the geographical location or preferences of the web user.

19. An electronic advertising system substantially as herein described with reference to any one of the accompanying drawings.

20. A method for clearing an electronic advertising board substantially as herein described with reference to any one of the accompanying drawings.

21. A method for selecting a new advertisement for insertion in an advertising slot in an electronic advertising board, substantially as herein described with reference to any one of the accompanying drawings.

22. A method for sorting advertisements in an electronic advertising board substantially as herein described with reference to any one of the accompanying drawings.
